(19) United States
(12) Patent Application Publication
(10) Pub. No.: US 2008/0012856 A1
(43) Pub. Date: Jan. 17, 2008

(54) Perception-based quality metrics for volume rendering

(76) Inventors: Daphne Yu, Yardley, PA (US); Jeffrey P. Johnson, Lawrenceville, NJ (US); Mariappan S. Nadar, Plainsboro, NJ (US); John S. Nafziger, Morrisville, PA (US); Thomas Stingl, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/800,565

(22) Filed: May 7, 2007

Related U.S. Application Data
(60) Provisional application No. 60/830,985, filed on Jul. 14, 2006.

(51) Int. Cl. G06T 17/00

(52) U.S. Cl. 345/424

(57) ABSTRACT

Perception-based visual quality metrics are used in volume rendering. A perception-based visual quality metric is measured from one or more three-dimensional representations. For example, people tend to notice edges, so a numeric value representing the noticeable edges is calculated. The perception-based metric is used for developing volume renderers, calibrating across different renderers, calibrating across different rendering platforms, determining rendering parameter values as a function of rendering speed, selecting rendering parameter values for a given situation, providing a range of rendering options associated with gradual perception changes, and/or combinations thereof. The perception-based visual quality metric provides a quantifiable representation of importance to the user for a given application, assisting optimization of volume rendering.

### RELATED APPLICATIONS

The present patent document claims the benefit of the filing date under 35 U.S.C. §119(e) of Provisional U.S. Patent Application Ser. No. 60/830,985, filed Jul. 14, 2006, which is hereby incorporated by reference.

### BACKGROUND

The present embodiments relate to volume rendering. In particular, medical data is volume rendered.

Volume rendering is a general method to composite 3D digital volumetric data onto a 2D image. The quality and appearance of the resulting image can vary widely from one volume rendering engine to another due to the choice of different engineering tradeoffs in different implementations. Even within one volume rendering engine, different image quality and appearance can be produced depending on the choice of parameters. Other than gross errors, there is often no right or wrong resulting image, only whether the resulting image is “better” or “worse” in revealing the desired features for a particular task or in minimizing the appearance of undesirable rendering artifacts.

The choice of rendering engine and parameters is often left up to the subjective heuristics of the software developers, who attempt to select parameters that would yield good quality given rendering speed performance considerations. The tendency for developer-driven heuristics is to focus the parameter controls from the low-level algorithmic point of view. The end user is presented with an abundance of incomprehensible parameters that affect the rendered image characteristics and quality in ways that are not necessarily clear in relation to the end user's task. The end user may just select higher or lower values for the parameters in an effort to increase speed or resolution without appreciating the result on appearance of features of importance to diagnosis. Furthermore, developer-chosen heuristics may limit choices to software development time, with little possibility for runtime adjustment based on actual data and runtime system conditions.

These problems are further compounded for applications that can be deployed with different volume rendering engines implemented on different system platforms, potentially also with different algorithms. It is difficult to provide consistency across deployment platforms. For example, an image rendered in a hospital using a workstation may be different than an image rendered on a doctor's laptop even though both renderings are for the same application (e.g., cardiac function).

Images resulting from volume rendering may be more quantitatively compared. For example, average subtracted differences or mean squared errors in luminance indicate an amount of difference between two images. However, these quantities may be of limited usefulness in determining how to best image for diagnosis.

### BRIEF SUMMARY

By way of introduction, the preferred embodiments described below include methods, systems, instructions, and computer readable media for using a perception-based visual quality metric in volume rendering. A perception-based visual quality metric is measured from one or more three-dimensional representations. For example, people tend to notice edges, so a numeric value representing the contribution of edges is calculated. The perception-based metric is used for developing volume renderers, calibrating across different renderers, calibrating across different rendering platforms, determining rendering parameter values as a function of rendering speed, selecting rendering parameter values for a given situation, providing a range of rendering options associated with gradual perception changes, other uses, and/or combinations thereof. The perception-based visual quality metric provides a quantifiable representation of importance to the user for a given application, assisting optimization of volume rendering to the user or application.

In a first aspect, a system is provided for a perception-based visual quality metric in volume rendering. A memory is operable to store a dataset representing a three-dimensional volume. A processor is operable to volume render, as a function of the first setting of the at least one rendering parameter, a two-dimensional representation from the dataset. The two-dimensional representation represents the volume, and the first setting is a function of the perception-based visual quality metric. A display is operable to display the two-dimensional representation of the volume. A visual aspect of the two-dimensional representation is more visually perceptible for the first setting than another two-dimensional representation of the volume rendered as a function of a second setting of the at least one rendering parameter.

In a second aspect, a method is provided for use of a perception-based visual quality metric in volume rendering. A processor predicts visibility to a user of an image feature. Volume rendering is performed as a function of the predicted visibility.

In a third aspect, a computer readable storage medium has stored therein data representing instructions executable by a programmed processor for a quality metric in volume rendering. The storage medium includes instructions for volume rendering an image representation of a volume from a data set representing the volume; and calculating a first quantity of a visual perception metric from the image representation.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a block diagram of one embodiment of a system for use of a perception-based visual quality metric in volume rendering;

FIG. 2 is a flow chart diagram of one embodiment of a method for use of a perception-based visual quality metric in volume rendering; and

FIG. 3 is a flow chart diagram of one embodiment of a method for comparing three-dimensional representations using a perception-based visual quality metric.

### DETAILED DESCRIPTION OF THE DRAWINGS AND PRESENTLY PREFERRED EMBODIMENTS

A visual image quality metric provides a quantitative quality measurement. The perception-based metric is computed from a visual discrimination model, which is based on responses of the primary physiological mechanisms in the human visual system. The output metric is a prediction of the visibility of image characteristics or of differences between images. A process or a combined measurement of various modeled neural processes may be modeled. Perception-based metrics may include features such as luminance sensitivity, contrast sensitivity, selective responses of spatial frequency, feature orientation, and/or psychophysical masking. The visibility of image features or differences between images may be measured quantitatively in standard psychophysical units of just-noticeable differences (JND).

Volume rendered images are commonly controlled by low-level, algorithm-specific engineering parameters that have no direct correlation with the end user perceived image qualities. The effect of parameter manipulation on rendered images can be measured using a mathematical error metric like mean-squared-error, which is typically uncorrelated with perceptual image differences. Visual image quality metrics may provide an objective measurement of image characteristics and perceptual quality during volume rendering algorithm development and parameter selection. The visual image quality metric may serve as a quality-driven volume rendering tool, a calibration tool measuring perceptual quality across volume rendering engines, a method to guide quality versus speed performance decisions, and a runtime tool for dynamic adjustment of volume rendering parameters based on data and system conditions.

FIG. 1 shows a system for use of a perception-based visual quality metric in volume rendering. The system includes a processor 12, a memory 14, a display 16, and a user input 18. Additional, different, or fewer components may be provided. For example, a network or network connection is provided, such as for networking with a medical imaging network or data archival system.

The system is part of a medical imaging system, such as a diagnostic or therapy ultrasound, x-ray, computed tomography, magnetic resonance, positron emission, or other system. Alternatively, the system is part of an archival and/or image processing system, such as associated with a medical records database workstation or networked imaging system. In other embodiments, the system is a personal computer, such as desktop or laptop, a workstation, a server, a network, or combinations thereof for rendering three-dimensional representations. For example, the system is part of a developer's computer system for designing or calibrating a rendering engine.

The user input 18 is a keyboard, trackball, mouse, joystick, touch screen, knobs, buttons, sliders, touch pad, combinations thereof, or other now known or later developed user input device. The user input 18 generates signals in response to user action, such as user pressing of a button.

The user input 18 operates in conjunction with a user interface for context based user input. Based on a display, the user selects with the user input 18 one or more controls, rendering parameters, values, quality metrics, an imaging quality, or other information. For example, the user positions an indicator within a range of available quality levels. In alternative embodiments, the processor 12 selects or otherwise controls without user input (automatically) or with user confirmation or some input (semi-automatically).

The memory 14 is a graphics processing memory, video random access memory, random access memory, system memory, cache memory, hard drive, optical media, magnetic media, flash drive, buffer, combinations thereof, or other now known or later developed memory device for storing data or video information. The memory 14 stores one or more datasets representing a three-dimensional volume for rendering.

Any type of data may be used for volume rendering, such as medical image data (e.g., ultrasound, x-ray, computed tomography, magnetic resonance, or positron emission). The rendering is from data distributed in an evenly spaced three-dimensional grid, but may be from data in other formats (e.g., rendering from scan data free of conversion to a Cartesian coordinate format or scan data including data both in a Cartesian coordinate format and acquisition format). The data is voxel data of different volume locations in a volume. The voxels are the same size and shape within the dataset. Voxels with different sizes, shapes, or numbers along a dimension may be included in a same dataset, such as is associated with anisotropic medical imaging data. The dataset includes an indication of the spatial positions represented by each voxel.

The dataset is provided in real-time with acquisition. For example, the dataset is generated by medical imaging of a patient. The memory 14 stores the data temporarily for processing. Alternatively, the dataset is stored from a previously performed scan. In other embodiments, the dataset is generated from memory, such as associated with rendering a virtual object or scene.

The processor 12 is a central processing unit, control processor, application specific integrated circuit, general processor, field programmable gate array, analog circuit, digital circuit, graphics processing unit, graphics chip, graphics accelerator, accelerator card, combinations thereof, or other now known or later developed device for rendering. The processor 12 is a single device or multiple devices operating in serial, parallel, or separately. The processor 12 may be a main processor of a computer, such as a laptop or desktop computer, may be a processor for handling some tasks in a larger system, such as in an imaging system, or may be a processor designed specifically for rendering. In one embodiment, the processor 12 is, at least in part, a personal computer graphics accelerator card or components, such as manufactured by nVidia (e.g. Quadro4 900XGL or others), ATI (e.g. Radeon 9700 or others), or Matrox (e.g. Parhelia or others).

Different platforms may have the same or different processor 12 and associated hardware for volume rendering. Different platforms include different imaging systems, an imaging system and a computer or workstation, or other combinations of different devices. The same or different platforms may implement the same or different algorithms for rendering. For example, an imaging workstation or server implements a more complex rendering algorithm than a personal computer. The algorithm may be more complex by including additional or more computationally expensive rendering parameters.

The processor 12 is operable to volume render a two-dimensional representation from the dataset. The two-dimensional representation represents the volume from a given or selected viewing location. Volume rendering is used in a general sense of rendering a representation from data representing a volume. The volume rendering is projection or surface rendering.

The rendering algorithm may be executed efficiently by a graphics processing unit. The processor 12 may be hardware devices for accelerating volume rendering processes, such as using application programming interfaces for three-dimensional texture mapping. Example APIs include OpenGL and DirectX, but other APIs may be used independent of or with the processor 12. The processor 12 is operable for volume rendering based on the API or an application controlling the API. The processor 12 is operable to texture map with alpha blending, minimum projection, maximum projection, surface rendering, or other volume rendering of the data. Other types of volume rendering, such as ray-casting, may be used.

The rendering algorithm renders as a function of rendering parameters. Some example rendering parameters include voxel word size, sampling rate (e.g., selecting samples as part of rendering), interpolation function, size of representation, pre/post classification, classification function, sampling variation (e.g., sampling rate being greater or lesser as a function of location), downsizing of volume (e.g., down sampling data prior to rendering), shading, opacity, minimum value selection, maximum value selection, thresholds, weighting of data or volumes, or any other now known or later developed parameter for rendering. The rendering parameters are associated with two or more options, such as a range of possible fractional or integer values. For example, pre/post classification (classification timing) may be a binary setting providing for mapping luminance to color before or after interpolation. The algorithm may operate with all or any sub-set of rendering parameters. The rendering parameters may be set for a given algorithm, such as a renderer operating only with pre-classification. Other rendering parameters may be selectable by the developer or end-user, such as selecting sampling rate and word size by a developer or selecting shading options by an end-user.

One or more settings of one or more rendering parameters are a function of a perception-based visual quality metric. The quality metric correlates with human perceptual ratings, so is more reliable as a quantitative measurement of what would be perceived in an image by a human observer. Example perception-base visual quality features contributing to the metrics include vertical features, horizontal features, orientation features, contrast sensitivity, luminance sensitivity, and/or psychophysical masking. The selection of features is adapted based on use cases and can be a combination of features. The feature set is based on the visual discrimination model simulation. The image digital pixel values are converted to luminance patterns for a given display device. To compute the features, the luminance input image is filtered by a set of biologically inspired spatial frequency and orientation tuned filters, breaking the imaging into 20 channels, at 5 different spatial frequencies (octave spacing from 0.5 cycles per degree to Nyquist/2) and 4 orientations (0, 45, 90, 135 degrees). The filtering is done by fast convolution, which transforms the image into the frequency domain using the Fast-Fourier transform (FFT) then point-by-point multiplication with the respective filter. Each channel is returned to the spatial domain by inverse FFT, with the complex values converted to real by taking the absolute value. Each channel is converted to local-contrast by dividing the pixel luminance by the local mean luminance. The local mean luminance is computed by fast convolution with a low-pass filter, whose pass-band is two octaves lower than the channel's peak band-pass frequency. The spatial frequency channels are weighted by a psychophysically measured contrast sensitivity function, where sensitivity varies with spatial frequency and luminance. Each channel or combinations of channels may be used as a metric. Other numbers of channels, groupings of features, divisions of spatial frequencies, and/or orientations may be used

The data may be separated by spatial frequency, such as determining quality metric values for data of the dataset at higher and lower frequencies. The dataset is low pass and high pass filtered. The quality metric is then determined from the two different filter outputs. Band pass or other spatial frequency isolation techniques may be used, such as to create three or more output datasets at three or more respective spatial frequencies.

The visual image quality metric is a two-dimensional map, linear map, or scalar measurement. For example, the metric is calculated for each pixel or groups of pixels for an image. Metric values as a function of two-dimensional distribution are provided and may be displayed as an image or contour map. The values of the quality metric may be combined or originally calculated along one or more lines for a linear map. For a scalar value, an average, mean, median, highest, lowest, or other function is used to calculate the metric from the map. Alternatively, the calculation outputs a scalar value.

The scalar value may be for an entire image or one or more regions of an image. For example, selecting a higher or lowest value identifies a region for metric. As another example, a region of a pre-determined size, user selected region, or automatically determined region is used. The region is centered on or otherwise placed to cover desired values of the metric, such as the highest value. The region is circular, square, rectangular, irregular, or other shape, such as to follow an edge feature. A threshold may be applied to identify a plurality of regions with sufficiently high or low values or to remove regions associated with very low or very high values. The scalar value is determined by the combination of mapped quality values within the region or regions. In another example, segmentation is performed to remove areas that are irrelevant to the user (e.g., regions outside the body).

One quality metric is used. Alternatively, more than one quality metric may be calculated. A plurality of quality metrics may be calculated as one value, such as applying a filter for outputting higher values for horizontal and vertical features. Alternatively, each quality metric is calculated separately as a channel.

The values for the channels are combined from a map (e.g., two-dimensional distribution) or the scalar values (e.g., single value of the metric for the image). For example, two-dimensional maps are generated for each visual channel and then combined across channels to create a composite map. Composite maps are generated by applying a maximum operation, Minkowski summation, or other combination function at each pixel location across the selected set of channels. Scalar metrics are then determined for the composite map by computing statistical measures, such as the mean and standard deviation of the quality metric values, or finding histogram values (e.g., the median or a high percentile (e.g., 90-99^{th}) value). As another example, scalar values are determined for each channel map. The scalar values are combined.

The channels, functions, combination, spatial frequency, or other factor for perception-based visual quality metrics used for a given rendering, rendering algorithm, or rendering engine may be based on the application. For a particular defined end user task, the choice of the scalar measurements are fine tuned to image features that are most important to the task at hand. Individual frequency or orientation channels, composite maps, or other information that most reflect the salient features are used for the application. For example, contrast based values are weighted more heavily for lung-nodule imaging applications than for heart wall function applications.

The rendering is performed as a function of the perception-based visual quality metric in development, calibration, or real-time usage. For example, a user selects rendering parameters to be included, possible rendering parameter settings, groups of settings, or other setting of a rendering algorithm based on the quality metric. The parameters (e.g., type of rendering) and/or parameter values associated with noticeable differences or just noticeable differences based on the quality metric are used. The quantitative feedback allows more optimal design to balance rendering speed or other performance with imaging results based on the perception of the user. Parameters or settings providing insufficient or no improvement in perception may be avoided to minimize user confusion or frustration.

As another example, different rendering algorithms and/or platforms are calibrated. The visual quality metric values are made the same or similar for a given situation, allowing more consistent use across the differences. Transitions between user selectable settings may be calibrated to provide noticeable differences. The quality metric quantities allow developers to consistently provide rendering performance adjustments that relate to visible features, rather than just rendering speed.

The perception-based visual quality metric is determined as a value for a given image, such as a volume rendered image. The difference between the values for different images may be compared. For example, a difference of values for the same perception-based visual quality metric between two different rendered images is calculated. The perceptual differences between different settings, algorithms, platforms, or other rendering factors are quantitatively represented by the difference. The difference may be calculated as a mathematical difference, a ratio, a percentage, or other function.

In one embodiment, the quality metric is calculated to indicate a difference from two or more images. The difference provides a visual image quality metric-based quantitative quality index. For example, one image is used as a frame of reference. The visual image quality metric relative to the frame or image of reference provides an index of the quality of a rendered image. The reference image may be at any quality level. For example, the scalar value or values between a particular rendered image and the reference image are calculated. In the case of a single volume rendering engine, the reference image may be the best image that this engine can produce with the highest resolution parameters. Each rendered image from various combinations of parameters is mapped to scalar quality values based on the magnitude of quality metric values between the current image and the reference image. The reference may be a lowest or other resolution image. The differences may be mapped to integer levels, negative values, and/or fractional levels.

The display 16 is a monitor, LCD, projector, plasma display, CRT, printer, or other now known or later developed devise for outputting visual information. The display 16 receives images, quality metric values, or other information from the processor 12. The received information is provided to the user by the display 16.

For example, the display 16 displays the two-dimensional representation of the volume. Where a setting of the rendering is selected as a function of the perception-based visual quality metric, the image may have a visual aspect more visually perceptible than for another setting. Two images rendered with different rendering settings have visual aspects more likely distinct, avoiding iterative adjustments having little or no visual difference for the end user.

The display 16 is part of a user interface. The user interface is for a developer or end-user. For a developer, the user interface may include one or more selectable quality metrics and output calculated values for a quality metric of a given image or between two images. The user interface for perception based quantification may be integrated with or separate from the volume rendering interface where the developer selects different rendering settings (e.g., parameters, values for parameters, and/or techniques). For an end user, the user interface may provide selectable levels of rendering where each level is associated with a perceptibly different visual aspect, limiting or avoiding unnecessary rendering adjustments.

The memory 14 and/or another memory stores instructions for operating the processor 12. The instructions are for determining and/or using a perception-based quality metric in volume rendering. The instructions for implementing the processes, methods, and/or techniques discussed herein are provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone, or in combination. Likewise, processing strategies may include multiprocessing, multitasking, parallel processing, and the like.

In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU or system.

The system of FIG. 1 or another system has various developmental, calibration, and/or end-user uses. In one embodiment, the perception-base visual quality metric is used as a methodology for the development of visual-quality-driven volume rendering. The volume rendering is developed for easier end-user use. For end-user use, the user input 18 receives an input of a selectable level of visual perception of an image feature. The processor 12 maps the input to one or more settings of one or more rendering parameters. A quality of the visual aspect is responsive to the input of the selectable level. For developer use, different rendering parameter settings are selected. Groups of settings associated with different qualities of a visual aspect associated with a given application are selected. The map of settings to visual quality level is created, providing steps in quality level associated with a visual aspect of the anatomy being represented in the image, rather than just resolution differences.

A visual image quality metric-based quantitative index of image quality is used or provided to the user. The index provides for task-specific visual quality driven volume rendering. Rather than making subjective heuristic decisions about quality by directly selecting different settings for rendering parameters, the rendering engine developer is empowered with a simple quantitative mapping between the quality of perceived image characteristics and the corresponding set of rendering algorithm parameters. Volume rendering parameters are controlled based on meaningful image features as perceived by an end user.

For example, if N images are produced from a rendering engine by varying the rendering parameters and each image is compared to a high-quality reference image, the visual image quality metric can be computed for each of the N images in a manner based on the most salient quality feature for a particular task. Settings associated with insufficient visual differences may be discarded. Each of the resulting visual image quality metric values are plotted and mapped to a single user interface parameter with N or a sub-set of possible values to control the level of image quality. The developer, in turn, maps the quality levels in this user interface to the sets of rendering parameters that produced the N or selected sub-set of images.

From the end-user perspective, the quality levels correspond to observable image features and can be adjusted without any knowledge about the underlying rendering algorithms. From a software component development point-of-view, this independence from algorithm-specific parameters may be used to derive a standardized quality parameter control interface. The same control of quality levels may be provided in different rendering algorithms, platforms, or engines. The user control may be easily exchangeable between platform-specific volume rendering components.

In another embodiment, the perception-base visual quality metric is used as a calibration tool for quality uniformity across volume rendering engines (e.g., algorithms, hardware, and/or both). The processor 12 assists calibration of different rendering images as a function of the perception-based visual quality metric. In practice, volume rendering engines are often deployed in various software and graphics hardware-based implementations. In some cases, the same software application is deployed with different volume rendering engines depending on the available platform. In these cases, the consistency of visual image quality across platforms is important. Measuring the uniformity of visual quality, however, is complicated by the fact that each volume rendering engine on each platform is controlled by different algorithm-specific rendering parameters and there may be no common reference image.

For example, test images are evaluated in all possible pairings (round-robin pairing) of rendered images produced by different rendering engines but with nominally the same quality settings. The resulting visual image quality metrics measure the degree of dissimilarity across the various engines and may be used to define a threshold or upper limit for an acceptable level of dissimilarity. If the level of measured quality metric value is above a desired threshold, the rendering parameters of one or both of the rendering engines are adjusted with the goal of achieving a better match in visual equivalency. This calibration process is repeated between each pair of volume rendering engines so that the visually noticeable differences for corresponding quality levels are below an acceptable threshold of difference.

In another embodiment, the perception-base visual quality metric is used as a calibration tool for controlling visual transitions between quality levels. The calibration is for different quality levels using a same rendering engine. Volume rendering engines may produce images using several predetermined quality settings or levels that affect the tradeoff between visual quality and rendering speed. From the end-user perspective, it is desirable for the increments between quality levels to be visually equal or similar to make the transition from low to high quality as smooth as possible. The visual magnitude of each quality step is determined by computing visual image quality metric values for each pair of consecutive images in a sorted sequence of quality levels.

The processor 12 renders with settings or groups of settings corresponding to at least a threshold difference in the value of a perception-based visual quality metric. For example, a sequence of images for the respective quality levels is rendered. The quality difference between images as a function of the perception-based visual quality metric is determined. The difference is between adjacent pairs of images in one embodiment. For each consecutive pair, one of the images is a reference image. Since consecutive pairs of reference and test images overlap in this scheme, a “sliding reference” image is used. The magnitude of each visual increment is measured and the variation plotted as a function of quality level. Rendering parameters may be adjusted to control the visual increments between quality levels and achieve the desired uniformity. If any visual increments fall below a developer-selected threshold, the design of the volume rendering engine may be simplified by retaining only the fastest renderer in each group of visually equivalent or similar quality settings.

In another embodiment, the perception-base visual quality metric is used as a tool for making quality versus speed performance decisions. The options available in a rendering algorithm or platform may be selected in a structured and objective way. The memory 14 stores groups of settings. Each group includes settings for a plurality of rendering parameters. Different rendering parameters may be provided as settings in different groups. Each group is associated with different quality levels. The quality levels are determined as a function of the perception-based visual quality metric. The settings within each group are further determined as a function rendering speed. For a given quality level, the settings with the greatest rendering speed are selected.

The visual image quality metric is used for evaluating quality and speed performance tradeoffs. For example, in certain volume rendering conditions, such as when the composited view is rendered from a very thick volume, the volume data is composited in such a way that little difference is perceived between rendering using a slower but theoretically more accurate method and rendering using a faster but theoretically less accurate method. The conditions under which this difference is “small enough” such that using the faster method is justifiable can be established using the perception-based metrics. When the difference in values of the perception-based visual quality metric between images rendered using the faster and slower method is below a certain threshold, the faster method is to be used. The rendering software or hardware is configured to provide the faster settings for the desired quality level. The options available to a user may be limited or conveniently provided based on the rendering speed and the visual aspect.

In another embodiment, the perception-base visual quality metric is used as a runtime tool for dynamic adjustment of rendering parameters based on actual data and system conditions. The processor 12 determines a value for the perception-based visual quality metric for each of multiple images rendered with different settings. The processor 12 selects settings as a function of the quality metric value and a rendering performance difference between the different settings. Differences in datasets, such as size or spacing, and/or differences in availability of rendering resources at a given time may result in different rendering speed or other performance. By determining the quality metric based on current datasets and conditions for two or more groups of settings, one or more groups of settings may be selected as optimal for current conditions. The current conditions are determined during runtime or are compared to previously determined ranges. For previously determined ranges, a look-up table or thresholds are used to identify settings appropriate for the current conditions.

This method of generating a quality verses performance tradeoff decision criterion may also be applied during development time. As an example for use during runtime, the composited view is rendered from a dataset above a certain thickness. The perceived difference between using different interpolation methods is very low for greater thicknesses. The rendering algorithm applies a rule that when the thickness is above a threshold, then the faster rendering method is to be used. The perception-base visual quality metric provides the developer or user an objective and systematic tool to establish the quality and performance tradeoff criterion with predictable quality consistency.

Other applications for development or rendering operation may be used.

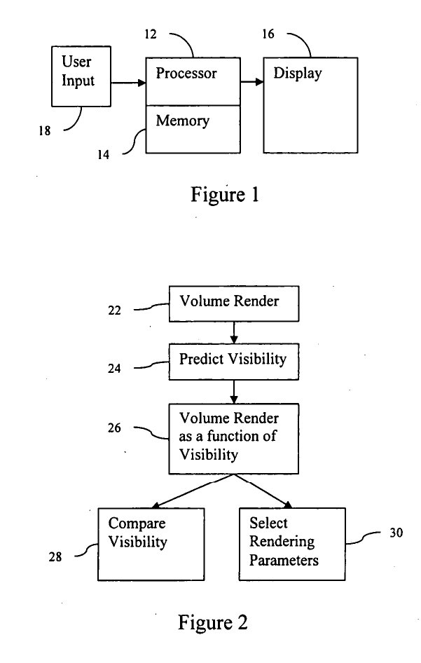

FIG. 2 shows a method for use of a perception-based visual quality metric in volume rendering. The method is implemented by the system of FIG. 1 or another system. The method is performed in the order shown or other orders. Additional, different, or fewer acts may be provided. For example, acts 28 and/or 30 are optional. As another example, act 26 is not performed. In another example, acts 22 and 24 are repeated for a different rendering.

A dataset for rendering is received with viewing parameters. The dataset is received from a memory, from a scanner, or from a transfer. The dataset is isotropic or anisotropic. The dataset has voxels spaced along three major axes or other format. The voxels have any shape and size, such as being smaller along one dimension as compared to another dimension.

The viewing parameters determine a view location. The view location is a direction relative to the volume from which a virtual viewer views the volume. The view location defines a view direction. The viewing parameters may also include scale, zoom, shading, lighting, and/or other rendering parameters. User input or an algorithm defines the desired viewer location.

Settings for rendering are also received. The settings are values for rendering parameters, selections of rendering parameters, selections of type of rendering, or other settings. The settings are received as user input, such as a developer inputting different settings for designing a rendering engine. Alternatively or additionally, the settings are generated by a processor, such as a processor systematically changing settings to determine performance and/or perception-based visual quality metric values associated with different settings.

In act 22, an image representation of a volume is volume rendered from the dataset representing the volume. Volume rendering is performed with the dataset based on spatial locations within the sub-volume. The rendering application is an API, other application operating with an API, or other application for rendering.

Any now known or later developed volume rendering may be used. For example, projection or surface rendering is used. In projection rendering, alpha blending, average, minimum, maximum, or other functions may provide data for the rendered image along each of a plurality of ray lines or projections through the volume. Different parameters may be used for rendering. For example, the view direction determines the perspective relative to the volume for rendering. Diverging or parallel ray lines may be used for projection. The transfer function for converting luminance or other data into display values may vary depending on the type or desired qualities of the rendering. Sampling rate, sampling variation, irregular volume of interest, and/or clipping may determine data to be used for rendering. Segmentation may determine another portion of the volume to be or not to be rendered. Opacity settings may determine the relative contribution of data. Other rendering parameters, such as shading or light sourcing, may alter relative contribution of one datum to other data. The rendering uses the data representing a three-dimensional volume to generate a two-dimensional representation of the volume.

In act 24, a processor predicts visibility to a user of an image feature. The image feature may be a diagnostically useful feature, such as typical visual characteristics of a type of tumor or specific tissue being sought. Alternatively, the image feature is more generic, such as tissue structures of any type.

Based on the image feature, one or more quantities of a visual perception metric are calculated from the image representation. For example, the perception-based visual quality metric is calculated from a feature set of vertical features, horizontal features, other oriented features, contrast sensitivity, luminance sensitivity, psychophysical masking, or combinations thereof. More than one quality metric may be calculated from the feature set. For example, values for a plurality of perception-based visual quality metrics are calculated, and the values are combined. Values for the metric or metrics may be calculated for one or more spatial frequency bands of the data. The values are for point locations, regions, or the entire image.

The quality metric value or values are for a single rendered representation. Alternatively, the quality metrics represent a difference between a plurality of rendered representations.

In act 26, volume rendering is performed as a function of the predicted visibility. The volume rendering algorithm is developed as a function of the feature visibility values, so the rendering by the algorithm is a function of the visibility. The presets or settings may be developed using the feature visibility values, so the resulting rendering using the settings is a function of the visibility values. The user may be presented with visibility levels for selection, so the resulting rendering using the corresponding settings is a function of the visibility values.

The volume rendering is the same or different than used for act 22. The volume rendering is performed with rendering parameters, such as sample size, sampling rate, classification timing, sample variation, volume size, or combinations thereof. The rendering parameter selection and/or values are selected as a function of the predicted visibility.

The volume rendering as a function of the visibility value may be used in one or more contexts. Acts 28 and 30 represent two such contexts.

In act 28, the predicted visibilities of different volume rendered images are compared. The comparison is based on separately determined visibility values or a visibility value representing a difference in visibility calculated from both images.

One context for comparison is calibration. Calibration is performed as a function of the visibility value. Visibility in images rendered between different algorithms (e.g., different rendering software), different rendering platforms (e.g., different rendering hardware), or combinations thereof is calibrated. Similar feature visibility based on user perception is quantified to provide more uniform rendering across different hardware and software. The settings for each renderer or platform are adjusted in development or after installation to provide more uniformity.

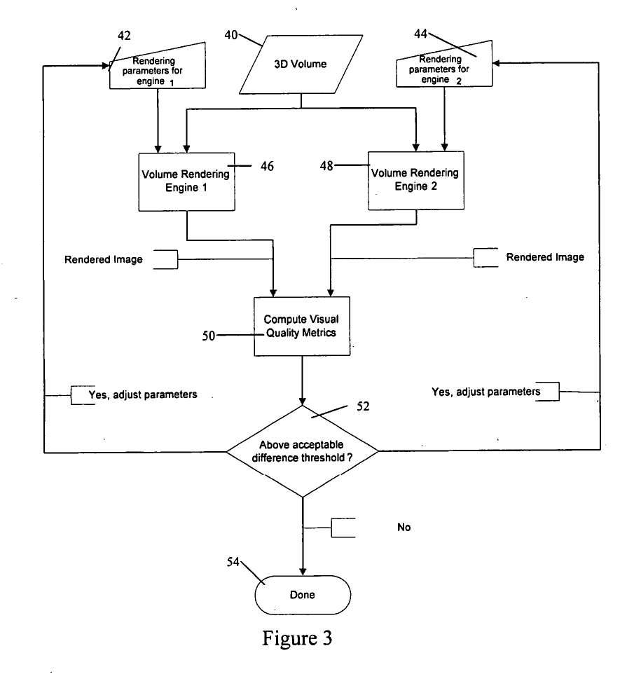

FIG. 3 shows one example method for implementing calibration across different algorithms and/or platforms. For example, the same rendering application (e.g., lung imaging) is implemented on different platforms. Due to hardware differences, the rendering algorithms may also be different. Similar rendering quality may be desired for one or more levels. The user expects the same rendering application to perform similarly even on different hardware and/or with different software.

In act 40, a same volume is provided. In acts 42 and 44, the volume rendering settings for the different hardware and/or software rendering engines are input. The parameters may be a best guess or current settings for a given quality level, such as the best, worst or other quality. In acts 46 and 48, the volume data set is rendered based on the parameters of acts 42 and 44. The rendered images are output. The perception-based visual quality metric is computed by a processor in act 50. Multiple values may be computed and/or combined. The values may indicate a predicted amount of differences, such as representing a level of just noticeable differences. The value of the metric is compared to a threshold in act 52. For example, the threshold is selected to indicate a desired level of similarity, such as a threshold of whether the perception differences are just noticeable or not. If the value is above “just noticeable,” the process repeats with different rendering settings in one or both of acts 42 and 44. The relative values of the two different images may indicate which group of settings to adjust or in which direction to adjust. The repetition continues until the rendered images are sufficiently similar, such as a just noticeable difference being below a threshold. The calibration, at least for a given quality level, is the complete in act 54.

Referring again to FIG. 2, the visibility values may be compared for other calibration. Visibility in images may be calibrated for more control of visibility transitions for different levels of the volume rendering. In addition to calibrating across platforms or used alone, the transitions in feature perceptibility between quality levels of a rendering engine are made gradual or follow any desired transition curve or steps. The transitions are set based on the visibility values. Different settings are used to identify one or more groups of settings for each desired quality level.

In act 30, values are selected for rendering parameters. The selection is a function of the perception-based visual quality metric quantity. Different levels of visibility are predicated as a function of values for rendering parameters. The user is provided with a user interface for selecting the quality level or other rendering level. The volume rendering is performed using the settings associated with the selected rendering level.

In another context, additional factors are used for determining the settings to be used. For example, both the perception-based visual quality metric value and rendering speed are used. Settings maximizing or considering both factors are determined and used. For example, more than one group of settings provide a similar predicted feature visibility to a user. Different groups provide a small difference in visibility predicted between images. The group of settings associated with the fastest rendering is selected. As another example, groups of settings providing similar rendering speed are provided. Different groups provide different visibility predicted between images. The group associated with a desired visibility of features is selected.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (we) claim:

1. A system for a perception-based visual quality metric in volume rendering, the system comprising:
a memory operable to store a dataset representing a three-dimensional volume; and
a processor operable to volume render, as a function of the first setting of the at least one rendering parameter, a two-dimensional representation from the dataset, the two-dimensional representation representing the volume, the first setting being a function of the perception-based visual quality metric;
a display operable to display the two-dimensional representation of the volume, a visual aspect of the two-dimensional representation being more visually perceptible for the first setting than another two-dimensional representation of the volume rendered as a function of a second setting of the at least one rendering parameter.

2. The system of claim 1 wherein the perception-based visual quality metric is a function of vertical features, horizontal features, angle features, contrast sensitivity, luminance sensitivity, psychophysical masking, or combinations thereof.

3. The system of claim 1 wherein the at least one rendering parameter comprises sample size, sampling rate, classification, sampling variation, volume size, rendering method, or combinations thereof.

4. The system of claim 1 wherein the processor is operable to determine a difference of a first value of the perception-based visual quality metric with a second value of the perception-based visual quality metric, the first value being for the two-dimensional representation and the second value being for another two-dimensional representation based on the second setting.

5. The system of claim 1 wherein the first setting is a function of combination of values of the perception-based visual quality metric and at least another perception-based visual quality metric.

6. The system of claim 1 further comprising:
a user input operable to receive an input of a selectable level of visual perception of an image feature;
wherein the processor is operable to map the input to the first, second or other setting of the at least one rendering parameter, a quality of the visual aspect responsive to the input of the selectable level.

7. The system of claim 1 wherein the processor is operable to calibrate different rendering images as a function of the perception-based visual quality metric.

8. The system of claim 1 wherein the processor is operable with the first, second, and a third settings, the first, second and third settings corresponding to at least a threshold difference in the perception-based visual quality metric.

9. The system of claim 1 wherein the memory is operable to store groups of settings, a first group including the first setting, each group for a plurality of rendering parameters, including the at least one rendering parameter, associated with different quality levels as a function of the perception-based visual quality metric, the groups being a function rendering speed.

10. The system of claim 1 wherein the processor is operable to determine a value for the perception-based visual quality metric and operable to select the first setting as a function of the value and a rendering performance difference between the first and second settings.

11. A method for use of a perception-based visual quality metric in volume rendering, the method comprising:
predicting, with a processor, visibility to a user of an image feature; and
volume rendering as a function of the predicted visibility.

12. The method of claim 11 wherein predicting comprises calculating the perception-based visual quality metric as a function of vertical features, horizontal features, orientation features, contrast sensitivity, luminance sensitivity, psychophysical masking, or combinations thereof.

13. The method of claim 11 wherein volume rendering comprises volume rendering with a value or values for sample size, sampling rate, classification, sample variation, volume size, rendering method, or combinations thereof, the value or values being selected as a function of the predicted visibility.

14. The method of claim 11 further comprising comparing the predicted visibility of a first volume rendered image with a predicted visibility of a second volume rendering image.

15. The method of claim 11 wherein predicting comprises calculating values for a plurality of perception-based visual quality metrics and combining the values.

16. The method of claim 11 wherein predicting comprises predicting different levels of visibility as a function of values for rendering parameters;
further comprising providing for user selection of one of the different levels;
wherein the volume rendering comprises rendering with the values corresponding to the selected level.

17. The method of claim 11 further comprising:
calibrating the visibility between different renderers, different rendering platforms, or combinations thereof.

18. The method of claim 11 further comprising:
generating, as a function of the visibility, visibility transitions for different levels of the volume rendering.

19. The method of claim 11 further comprising:
selecting rendering parameters as a function of rendering speed and differences in the visibility predicted for different rendering parameters.

20. In a computer readable storage medium having stored therein data representing instructions executable by a programmed processor for a quality metric in volume rendering, the storage medium comprising instructions for:
volume rendering an image representation of a volume from a data set representing the volume; and
calculating a first quantity of a visual perception metric from the image representation.

21. The instructions of claim 20 further comprising:
calibrating as a function of the first quantity.

22. The instructions of claim 20 further comprising:
selecting values for rendering parameters as a function of the quantity.
